(19) United States
(12) Patent Application Publication
(10) Pub. No.: US 2018/0160042 A1
(43) Pub. Date: Jun. 7, 2018

(54) APPARATUS AND METHOD FOR CONTROLLING CAMERA ARRAY

(71) Applicant: Shanghai Xiaoyi Technology Co., Ltd., Shanghai (CN)

(72) Inventor: Chao HE, Beijing (CN)

(73) Assignee: Shanghai Xiaoyi Technology Co., Ltd.

(21) Appl. No.: 15/819,568

(22) Filed: Nov. 21, 2017

(30) Foreign Application Priority Data
Dec. 5, 2016 (CN) 201611105497.9

(51) Int. Cl. H04N 5/232; H04N 13/00

(52) U.S. Cl. CPC H04N 5/23238; H04N 13/0018; H04N 13/004; H04N 13/0418

(57) ABSTRACT

Apparatus and methods for controlling a camera array are disclosed. According to certain embodiments, a camera system may include a plurality of cameras and a controller coupled to the cameras. The controller may be configured to: activate the cameras; determine at least one of hardware or software conditions of the cameras; when the conditions of the cameras are normal, synchronize an operation mode and operation parameters used in the operation mode to the cameras; when determining that at least one of the operation mode or the operation parameters is not set successfully, generate an alert message; instruct the cameras to initiate an operation; after the operation is initiated, monitor operation status of the cameras; and when an abnormal operation status is detected, instruct the cameras to stop the operation.

### CROSS-REFERENCE TO RELATED APPLICATION

This application is based upon and claims priority from Chinese Patent Application No. 201611105497.9, filed on Dec. 5, 2016, the disclosure of which is expressly incorporated herein by reference in its entirety.

### TECHNICAL FIELD

The present disclosure generally relates to imaging systems, and more specifically to apparatus and method for controlling a camera array.

### BACKGROUND

With the proliferation of virtual reality (VR) technology and the enthusiasm towards VR experiences, there is a high demand for using multiple cameras to shoot photos or video footages. However, many conventional VR camera systems only use a limited number of cameras, e.g., 2˜4 cameras, and thus have a limited field-of-view coverage. For example, these systems cannot produce 360-degree panoramic images.

Moreover, to produce high-quality VR photos and/or videos, the operations of the multiple cameras need to be preciously synchronized. As such, camera operators often have to spend tremendous time and effort in manually calibrating and setting operation parameters used by each individual camera. This is cumbersome. As the number of used cameras increases, this task may quickly become unmanageable by one person. Although some sophisticate VR image processing programs have been developed to combine (e.g., stitch) the images captured by different cameras and thus allow the cameras to work in an unsynchronized manner, the software-based imaging processing is time consuming and has a high requirement for computing resources, while the generated VR content still suffers from image quality loss due to the cameras not being in synchronization.

Furthermore, cameras used in the conventional VR camera system often work independently and have no effective means to communicate with other cameras or report their operation statuses to a camera operator. For example, each camera in a VR camera system may cover a different part of the scene to be imaged. Thus, the content recorded by each camera is indispensable for producing the VR content. If one of the cameras experiences a failure and stops working in the middle of a recording while this failure is unnoticed by the camera operator, then the photos/videos recorded by other cameras of the system after the occurrence of the failure are no longer useful for VR generation. This problem worsens when the VR camera system uses a large number of cameras, as it is difficult for a camera operator to attend to multiple cameras at the same time.

Thus, it is desirable to develop a controller to perform centralized controlling and/or monitoring of the multiple cameras, in order to coordinate the operations of different cameras and free the camera operators from the daunting tasks of camera calibrations and/or image processing. The disclosed systems and methods address one or more of the demands listed above.

### SUMMARY

Consistent with one embodiment of the present disclosure, a camera system is provided. The system may include a plurality of cameras and a controller coupled to the cameras. The controller may be configured to activate the cameras; determine at least one of hardware or software conditions of the cameras; when the conditions of the cameras are normal, instruct the cameras to initiate an operation; after the operation is initiated, monitor operation status of the cameras; and when an abnormal operation status is detected, instruct the cameras to stop the operation.

Consistent with another embodiment of the present disclosure, a method for controlling a plurality of cameras is provided. The method may include activating the cameras; determining at least one of hardware or software conditions of the cameras; when the conditions of the cameras are normal, instructing the cameras to initiate an operation; after the operation is initiated, monitoring operation status of the cameras; and when one or more of the cameras have abnormal operation status, instructing the cameras to stop the operation.

Consistent with yet another embodiment of the present disclosure, a non-transitory computer-readable storage medium storing instructions for controlling a plurality of cameras is provided. The instructions cause a processor to perform operations including activating the cameras; determining at least one of hardware or software conditions of the cameras; when the conditions of the cameras are normal, instructing the cameras to initiate an operation; after the operation is initiated, monitoring operation status of the cameras; and when one or more of the cameras have abnormal operation statuses, instructing the cameras to stop the operation.

It is to be understood that both the foregoing general description and the following detailed description are exemplary and explanatory only and are not restrictive of the invention, as claimed.

### DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a camera system, according to an exemplary embodiment.

FIG. 2 is a block diagram of a system for controlling a camera array, according to an exemplary embodiment.

FIG. 3 is a block diagram of a controller used in the system shown in FIG. 2, according to an exemplary embodiment.

FIG. 4 is a flowchart of a method for controlling a camera array, according to an exemplary embodiment.

FIG. 5A is a schematic diagram illustrating a user interface displaying the checking results of a plurality of camera modules, according to an exemplary embodiment.

FIG. 5B is a schematic diagram illustrating a user interface displaying the current hardware and/or software conditions of a camera module shown in FIG. 5A, according to an exemplary embodiment.

FIG. 6A is a schematic diagram illustrating an operation-parameter displaying page shown by a user interface, according to an exemplary embodiment.

FIG. 6B is a schematic diagram illustrating an operating-parameter setting page shown by a user interface, according to an exemplary embodiment.

FIG. 7A is a schematic diagram illustrating a user interface after image recording is initiated, according to an exemplary embodiment.

FIG. 7B is a schematic diagram illustrating a user interface when an abnormal operation status is detected, according to an exemplary embodiment.

FIG. 8 is a schematic diagram illustrating a Bluetooth® remote control, according to an exemplary embodiment.

FIG. 9 is a schematic diagram illustrating a user interface of a mobile phone, according to an exemplary embodiment.

FIG. 10A is a schematic diagram illustrating a user interface for selecting one or more camera modules for image preview, according to an exemplary embodiment.

FIG. 10B is a schematic diagram illustrating a user interface in a preview mode, according to an exemplary embodiment.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

Features and characteristics of the present disclosure, as well as methods of operation and functions of related elements of structure and the combination of parts and economies of manufacture, may become more apparent upon consideration of the following description with reference to the accompanying drawings, all of which form a part of this specification. It is to be understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

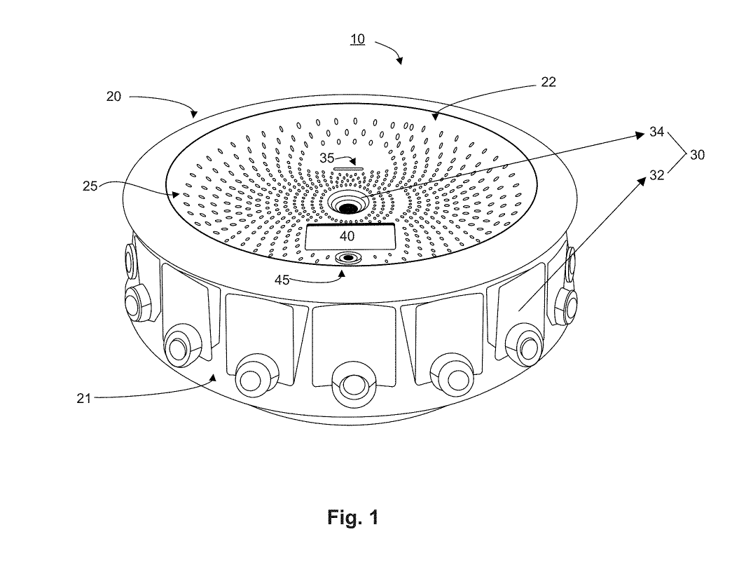

FIG. 1 is a schematic diagram illustrating a camera system 10, according to an exemplary embodiment. Referring to FIG. 1, camera system 10 may include a camera rig 20, which can house a camera array 30. Consistent with the disclosed embodiments, camera array 30 may be used for producing VR content.

Camera rig 20 may be a structure used for mounting camera array 30. Camera rig 20 may be built to form a specially designed camera path. Industry standard trussing and grip gear can be used in conjunction with various custom rigging solutions to allow substantial flexibility with positioning, height, and camera movement. Camera rig 20 may include complex structures that include multiple circles and curves with various diameters, straight tracks, incline/decline angles, overhead rigging, etc. Camera rig 20 may also be as simple as a single straight or curved track. For example, in 360-degree panorama photography, camera rig 20 may form a 360-degree circle for aligning camera array 30.

As shown in FIG. 1, in one embodiment, camera rig 20 may have a cylinder-like shape. Correspondingly, camera array 30 may include a plurality of camera modules 32, e.g., sixteen camera modules 32, arranged on a side wall 21 of camera rig 20. Camera modules 32 may have their lens oriented to capture image data of a scene from multiple directions at the side of camera rig 20. In the following description, camera module 32 may also be referred to as “side view camera module 32.” In one embodiment, camera modules 32 may be evenly separated and mounted along side wall 21 and adjacent camera modules 32 may have their field of view partially overlapped, such that 360-degree panorama may be created based on images captured by camera modules 32. For example, source images taken by some or all of camera modules 32 at the same time or at different points in time may be stitched together to generate a 360-degree panoramic image.

Side wall 21 may include multiple slots for receiving camera modules 32. Each slot may include a Universal Serial Bus (USB) port (not shown in FIG. 1) for connecting to a camera module 32. As such, each camera module 32 may also include a USB interface which can couple the camera module 32 to camera rig 20. The USB interface may be located on the bottom or the back of each camera module 32. This way, each camera module 32 may communicate, via the USB connections, with other camera modules mounted on camera rig 20. With the USB connections, individual camera modules 32 may be flexibly removed from or add onto camera rig 20, making camera system 10 a modular system that can be flexibly configured.

In some embodiments, camera array 30 may also include one or more camera modules 34 located on a surface 22 of camera rig 20. Camera modules 34 may be pointed up and configured to capture a scene above camera rig 20. As such, in the following description, camera module 34 may also be referred to as “top view camera module 34.” Similarly, camera array 30 may include one or more camera modules located on a bottom surface (not shown) of camera rig 20 and configured to capture a scene below camera rig 20.

In some embodiments, two or more of camera modules 32 and 34 may be positioned to have a sufficient field-of-view overlap so that certain parts of a scene can be seen by more than one camera module. As described above, such overlap is suitable for creating the VR effects. Moreover, capturing an object by more than one camera module may be beneficial for correcting exposure or color deficiencies in the images captured by camera array 30. Other benefits include disparity/depth calculations, stereoscopic reconstruction, and the potential to perform multi-camera high-dynamic range (HDR) imaging using an alternating mosaic pattern of under- and over-exposure across camera array 30.

In some embodiments, each camera module 32 or 34 may include one or more memory cards for storing raw image data captured by the respective camera module 32 or 34. Example memory cards include, but are not limited to, a secure digital (SD) memory card, a secure digital high capacity (SDHC) memory card, a secure digital extra capacity (SDXC) memory card, and a compact flash (CF) memory card, etc. For example, top surface 22 may include a card slot 35 for receiving a memory card used by top view camera module 34.

Camera rig 20 may be constructed from a heat dissipating material that draws heat from camera array 30 for dissipation in the atmosphere. As shown in FIG. 1, top surface 22 may also include multiple pinholes 25 for facilitating the dissipation of heat generated by camera array 30 and other components of camera system 10, such as a controller or control board (not shown) used by camera system 10. Other mechanisms for aiding in heat dissipation within camera system 10 may include tubing for running water throughout camera system 10 to cool the components of camera system 10, a silent fan for blowing hot air out of the camera system 10 via pinholes 25, heat sinks, and heat dissipating putty.

Camera system 10 may also include a user interface 40 located on top surface 22. User interface 40 may be configured to present certain information regarding the statuses of camera array 30 to a camera operator. User interface 40 may also be configured to receive user input for controlling certain functions of camera array 30. For example, user interface 40 may include a display panel for outputting images, videos, and/or other types of visual information to the operator. The display panel may include a liquid crystal display (LCD), a light-emitting diode (LED) display, a plasma display, or any other type of display. The display panel may have one or more associated or embedded speakers (not shown) for broadcasting audio messages. As another example, user interface 40 may include various input devices, such as a knob, a dial, a keyboard, and/or a touch screen for the operator to set the operation parameters of camera array 30 and/or enter other settings for camera system 10.

In the disclosed embodiments, camera system 10 may also include one or more hot buttons for triggering various functions of camera system 10. These hot buttons may locate at various places on the surface of camera rig 20. As shown in FIG. 1, top surface 22 may include a hot button 45. For example, a camera operator may press hot button 45 a first time to activate camera system 10. The operator may press hot button 45 a second time to start image recording by camera array 30. The operator may press hot button 45 a third time to stop the recording of the image data.

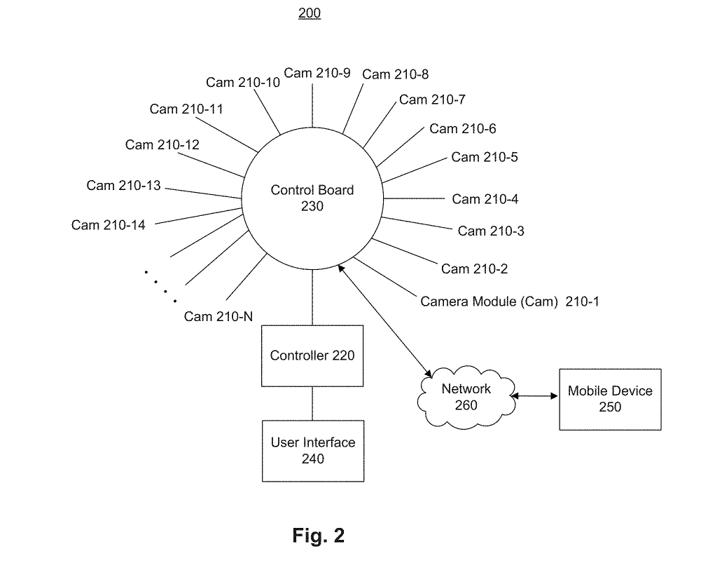

FIG. 2 is a block diagram of a system 200 for controlling a camera array, according to an exemplary embodiment. Referring to FIG. 2, system 200 may include a plurality of camera modules 210 (e.g., camera modules 210-1, 210-2, . . . 210-N), a controller 220, a control board 230, a user interface 240, a mobile device 250, and a network 260. For example, system 200 may be part of camera system 10. As such, camera module 210 may be implemented as camera module 32 or 34 (FIG. 1), and incorporate the above-described features regarding camera module 32 or 34. Similarly, user interface 240 may be implemented as user interface 40 (FIG. 1), and incorporate the above-described features regarding user interface 40.

Camera module 210 may be an image capturing device that includes any of optical devices, lenses, charge coupled devices (CCD), complementary metal-oxide-semiconductor (CMOS) detector arrays and driving circuitry, and other arrangements of optical components, electronic components, and control circuitry used in transmitting and receiving light of various wavelengths. For example, camera module 210 may be an action camera, a digital camera, a web camera, or digital single-lens reflex (DSLR) camera. Camera module 210 may also be imbedded in another device, such as a smartphone, a computer, a personal digital assistant (PDA), a monitoring device, etc.

Camera module 210 may be configured to capture one or more images in a variety of ways. For example, camera module 210 may be configured to capture images initiated by a user, by programming, by a hardware setting, or by a combination thereof. In some embodiments, when camera module 210 is configured to capture images by software or hardware programming or by a hardware setting, image capture can be performed at one or more predetermined conditions. For example, multiple camera modules 210 may be controlled by controller 220 to capture images simultaneously or in an ordered fashion. Alternatively, or additionally, a set of predetermined conditions, for example, the sensing of a moving object, can trigger camera module 210 to capture images. In some embodiments, capturing images may include placing camera module 210 in a mode or setting capable of capturing one or more images. As used herein, an “image” can refer to, in part or in whole, a static or dynamic visual representation including, but not limited to, a photo, a picture, a graphic, a video, a hologram, a virtual reality image, an augmented reality image, other visual representations, or combinations thereof.

Camera module 210 may include various features suitable for VR creation. In one embodiment, camera module 210 may use a 16MP (megapixel) light sensor capable of capturing high-resolution (e.g., 4608×3456) photos with enhanced color and contrast. Camera module 210 may also have a wide field of view, such as a 155-degree viewing angle. Camera module 210 may further be configured to record videos with various resolutions and frame rates, such as 1296p at 30 fps, and 1080p at 30 fps or 60 fps.

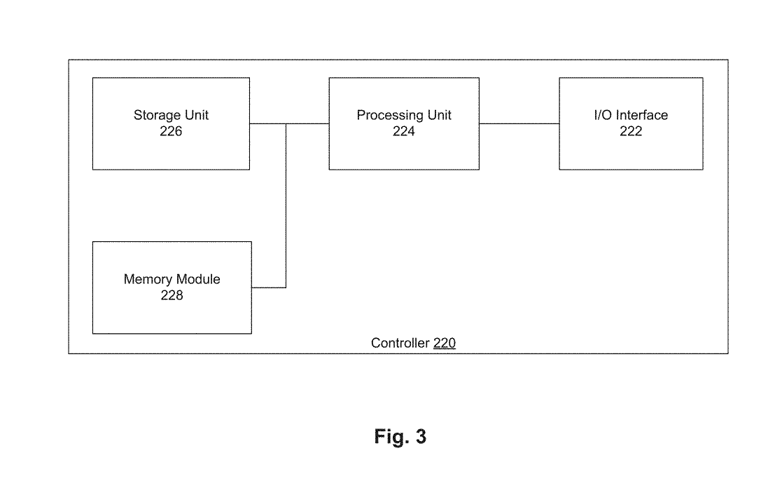

Controller 220 may be configured to control and monitor the operations of camera modules 210. FIG. 3 is a block diagram of controller 220, according to an exemplary embodiment. Referring to FIG. 3, controller 220 may include, among other things, an input/output (I/O) interface 222, a processing unit 224, a storage unit 226, and/or a memory module 228. These units may be configured to transfer data and send or receive instructions between or among each other.

I/O interface 222 may be configured for two-way communication between controller 220 and various components of camera modules 210 and other devices, such as user interface 240. For example, I/O interface 222 may receive certain signals transmitted from one or more camera modules 210 (e.g., signals indicating the current temperature of a camera module 210) and relay the signals to processing unit 224 for further processing. As another example, I/O interface 222 may receive instructions generated by processing unit 224 (e.g., an instruction commanding one or more camera modules 210 to initiate video recording) and transmit the instructions to camera module 210 for execution.

Processing unit 224 may be implemented with one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. Processing unit 224 may execute computer instructions (program code) and perform functions in accordance with techniques described herein. Computer instructions include routines, programs, objects, components, data structures, procedures, modules, and functions, which perform particular functions described herein.

Each of storage unit 226 and/or memory module 228 includes one or more memories configured to store the instructions and data used for controlling and monitoring camera modules 210. The memories may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

Storage unit 226 and/or memory module 228 may be configured to store the computer instructions and data that may be used by processing unit 224 to perform functions consistent with the present disclosure. For example, storage unit 226 and/or memory module 228 may store common used operation parameters used by camera module 210 for creating VR content.

In some embodiments, controller 220 may communicate with camera modules 210 via control board 230. Control board 230 may include a bus for facilitating communications between camera modules 210 and controller 220. The bus may correspond to one or more protocols or standards. For example, the bus may include one or more of the following: USB port (e.g., USB 2.0, 3.0, or Type-C); a High-Definition Multimedia port; a Lightning connector; or any other hardware bus that is similar or derivative of those described above.

To instruct camera modules 210 to perform certain operations or prescribe certain settings for camera modules 210, controller 220 may send the instructions and/or settings to control board 230, which then distributes the instructions and/or settings to camera modules 210. Similarly, control board 230 may receive from camera modules 210 streams of signals describing the real-time operation statuses of camera modules 210. Control board 230 may then aggregate the signals and transmit the aggregated signals to controller 220. In some embodiments, control board 230 may include a memory card or other non-transitory memory where the data exchanged between camera modules 210 and controller 220 may be temporality cached.

In some embodiments, control board 230 may be configured to communicate with a mobile device 250 via a network 260. Network 260 may be any type of wired or wireless network that may allow transmitting and receiving data. For example, network 260 may be a wired network, a local wireless network (e.g., Bluetooth®, Wi-Fi, near field communications (NFC), etc.), a cellular network, an Internet, or the like, or a combination thereof. Other known communication methods which provide a medium for transmitting data are also contemplated.

In some embodiments, control board 230 may include a port such as a USB, SD, RJ45, or similar port for wired communication with mobile device 250. In some embodiments, control board 230 may include a wireless transceiver for exchanging data with mobile device 250 using one or more wireless communication methods, including IEEE 802.11, IEEE 802.16, BLUETOOTH® or another suitable wireless communication method.

Consistent with the disclosed embodiments, various components of system 200 may collaborate to control and/or monitor the operations of camera modules 210. For example, in some situations, top view camera modules 34 may not be needed for creating the VR content. Accordingly, controller 220 may control the activation/deactivation of top view camera modules 34 independently from side view camera modules 32. When the camera operator only use side view camera modules 32 to record image data, controller 220 may send a deactivation signal to top view camera modules 34 to turn off top view camera modules 34.

For another example, when camera modules 220 are recording image data, controller 220 may periodically check the operation status (e.g., temperature, remaining free storage space of memory card, etc.) according to a predetermined schedule. If controller 220 detects that a camera module 210 experiences a system failure, controller 220 may instruct the failed camera module 210 to generate a warning message, such as a beeping sound, so as to alert the camera operator. Based on the operator's preference, controller 220 may adjust the volume level of the beeping sound. For example, when the operator works in a large studio, controller 220 may turn up the warning sound, so that the operator can hear the beeping sound even if the operator is far away from a failed camera module 210. Conversely, when the operator works in a small room, controller 220 may turn down the volume of the warning sound to a level comfortable for the operator.

For another example, controller 220 may be configured to perform certain operations on multiple camera modules 210 at once. In one example, controller 220 may reset the operation parameters of all camera modules 220 to the default settings. Controller 220 may also format the memory cards in all camera modules 220.

For yet another example, as described in more detail below, controller 220 may establish a wireless connection (e.g., Wi-Fi or Bluetooth® connection) with mobile device 250 via control board 230. This way, mobile device 250 may be used by the camera operator to control and/or monitor the operations of camera modules 210.

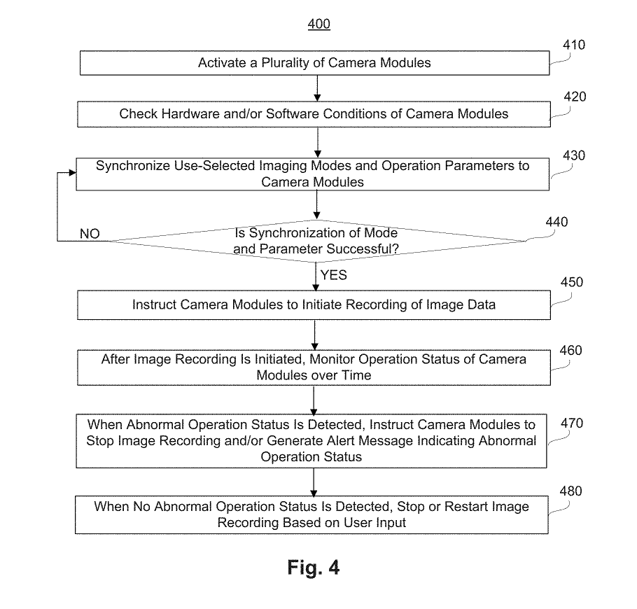

FIG. 4 is a flowchart of a method 400 for controlling a camera array, according to an exemplary embodiment. For example, method 400 may be performed by system 200. Referring to FIG. 4, method 400 may be started with controller 220 activating a plurality of camera modules 210 (step 410). For example, system 200 may be initially turned off or in an idling state. When an operator presses hot button 45, controller 220 may be switched on and subsequently send trigger signals to camera modules 210. The trigger signals may serve to activate camera modules 210.

In step 420, controller 220 may check the hardware and/or software conditions of camera modules 210. After system 200 is activated, controller 220 may immediately determine whether the hardware and/or software conditions of camera modules 210 are suitable for recording images for creating the VR effects.

The hardware and/or software conditions may include any condition that affects the proper operation of camera modules 210 and/or the synchronization among camera modules 210. For example, the conditions to be checked by controller 220 may include but are not limited to: whether a camera module 210 is activated; whether communication between the camera module 210 and controller 220 is established properly; whether the camera module 210 experiences a system crash; whether the camera module 210 is installed with a memory card; whether the memory card can be read and/or written properly; the remaining free storage space of the memory card; the temperature of the camera module 210; the version of the firmware used by the camera module 210; whether all the camera modules 210 currently use the same set of operation parameters (e.g., same ISO, same shutter speed, etc.); the state of charge (SoC), state of health (SoH), and/or remaining time of the battery used by each camera module 210; and/or the serial number of each camera module 210.

By knowing above conditions for each camera module 210, the camera operator may determine whether system 200 is ready for recording image data and, more particularly, shooting photos and/or videos for creating VR content. For example, if the memory card of a camera module 210 is full or almost full, controller 220 may alert the operator to replace the memory card or format the memory card. As another example, if camera modules 210 use different versions of firmware, controller 220 may alert the operator to update the firmware in all the camera modules 210 to the same version, so as to ensure the image data recorded by different camera modules 210 to have consistent quality and format. As yet another example, if the battery remaining time of one or more camera modules 210 is below a predetermined level, controller 220 may conclude such battery remaining time is too short for performing any imaging operation and alert the operator to the same.

Moreover, for VR creation, controller 220 may also check whether the values of the same operation parameter used by different camera modules 210 are the same or follow a predetermined relationship. For example, it may be desirable for all the camera modules 210 to use the same setting for the white balance, so as to generate VR content with consistent color quality. As another example, the ISOs used by camera modules 210 located at different positions, such as side view camera modules 32 and top view camera modules 34, may be desired to follow a fixed ratio, e.g., 1600 for side view camera modules 32 and 800 for top view camera modules 34. This is because top view camera modules 34 often face a brighter environment than side view camera modules 32.

To determine the above hardware and/or software conditions, controller 220 may send an inquiry to each camera module 210, which then runs a self-check process in response to the inquiry and reports the checking results to controller 220. When the hardware and/or software conditions of a camera module 210 is determined to be normal, controller 220 may conclude that the camera module 210 is ready for recording image data and may instruct user interface 240 to indicate the same. Conversely, when at least one of the hardware or software conditions of the camera module 210 is determined to be abnormal, controller 220 may conclude that the camera module 210 is not suitable for recording image data and may instruct user interface 240 to display the same.

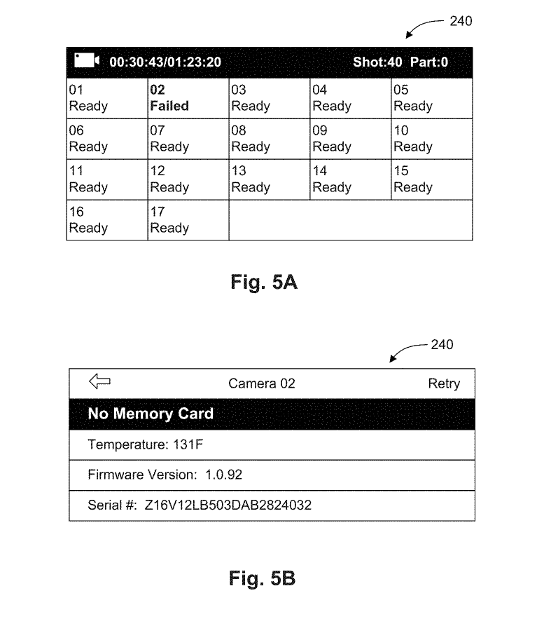

FIG. 5A is a schematic diagram illustrating user interface 240 displaying the checking results of a plurality of camera modules 210, according to an exemplary embodiment. In the example shown in FIG. 5, system 200 may contain seventeen camera modules 210. User interface 240 may display the checking result for each of the seventeen camera modules 210. For example, user interface 240 may display that all camera modules 210 are “ready” for recording image data except for “Camera 02,” which has “failed” the checking.

Still referring to FIG. 5A, user interface 240 may be a touch screen. When the camera operator touches user interface 240 and selects an icon that represents a camera module 210, user interface 240 may display the current hardware and/or software conditions of the selected camera module 210, according to the checking result. If the selected camera module 210 has failed the checking, the displayed hardware and/or software conditions may indicate the reason(s) for the failure.

FIG. 5B is a schematic diagram illustrating user interface 240 displaying the current hardware and/or software conditions of camera 02 shown in FIG. 5A, according to an exemplary embodiment. Referring to FIG. 5B, user interface 240 may display detailed information regarding Camera 02's memory card condition, temperature, firmware version number, and/or serial number. Since Camera 02 has failed the checking, the detailed information may indicate the reason(s) for the failure. For example, in FIG. 5B, user interface 240 indicates that “no memory card” is detected in Camera 02, the temperature of Camera 02 is “131F,” the firmware version is “1.0.92,” and the serial number is “Z16V12LB503DAB2824032.” As such, the failure of Camera 02 is caused by the absence of the memory card. In one embodiment, user interface 240 may contrast the condition causing the failure from the rest of the displayed information, so as to alert the camera operator about this condition. For example, user interface 240 may highlight the message of “no memory card” in a different background color, in bold font, in a different font color, in a different font size, etc.

After seeing the condition causing the failure, the camera operator may perform various operations to fix the failure. For example, if the “no memory card” condition is indeed because of a memory card being missing from camera 02, the operator may insert a memory card into Camera 02. As another example, if Camera 02 already has a memory card and the “no memory card” is due to Camera 02's failure to recognize the memory card, the operator may perform operations such as unplugging and replugging the memory card, restarting system 200, restarting Camera 02 only, etc.

In some embodiments, user interface 240 may also display possible ways for the operator to fix the problems of a failed camera module 210. For example, referring to the “no memory card” condition, user interface 240 may display a list of possible solutions, including: “unplug and then replug the memory card,” “restart system 200,” “disconnect and then reconnect the power line,” etc.

User interface 240 may also provide an option for the camera operator to recheck a failed camera module 210. For example, still referring to FIG. 5B, a “retry” button may be displayed on the upper right corner of user interface 240, such that when the operator press the “retry” button, controller 220 may check the hardware and/or software conditions of Camera 02 again. In the disclosed embodiments, during the “retry” process, controller 220 may recheck all the hardware and/or software conditions of Camera 02. Alternatively, controller 220 may only recheck the condition(s) that causes the previously detected failure, e.g., “no memory card.”

Referring back to FIG. 4, after camera modules 210 are determined to be ready for recording image data, controller 220 may synchronize user-selected imaging modes and operation parameters to camera modules 210 (step 430). For example, in some embodiments, camera modules 210 may be capable of operating in three imaging modes: photo recording mode, video recording mode, and time-lapse video recording mode (i.e., recording video frames at set time intervals). Each imaging mode may have certain associated operation parameters. Based on input of the camera operator, controller 220 may instruct camera modules 210 to set an imaging mode and the operating parameters used in the selected imaging mode.

In the disclosed embodiments, exemplary operation parameters used in the photo recording mode may include:
Resolution: 16MP (e.g., 4608×3456)/12MP (e.g., 4000×3000)
Metering Mode: Spot/Center
Shutter Exposure Time: Auto/2 s/5 s/10 s/20 s/30 s
White Balance (WB): Auto/Native/Tungsten/Daylight/Cloudy
Flat Color: ON/OFF
ISO: Auto/100/200/400/800
Exposure Value (EV): +2.0/+1.5/+1.0/+0.5/0/−0.5/−1.0/−1.5/−2.0

Exemplary operation parameters used in the video recording mode may include:
Resolution: 2.5K (2560×1920) at 30 fps/4K (3840×2160) at 30 fps
Metering Mode: Spot/Center
WB: Auto/Native/Tungsten/Daylight/Cloudy
Flat Color: ON/OFF
ISO: Auto/400/1600/6400;
EV: +2.0/+1.5/+1.0/+0.5/0/−0.5/−1.0/−1.5/−2.0

Exemplary operation parameters used in the time-lapse video recording mode may include:
Time Interval: 0.5 s/1 s/2 s/5 s/10 s/30 s/60 s
Video Length: Unlimited/6 s/8 s/10 s/20 s/30 s
Resolution: 2.5K at 30 fps/4K at 30 fps
Metering Mode: Spot/Center
Flat Color: ON/OFF

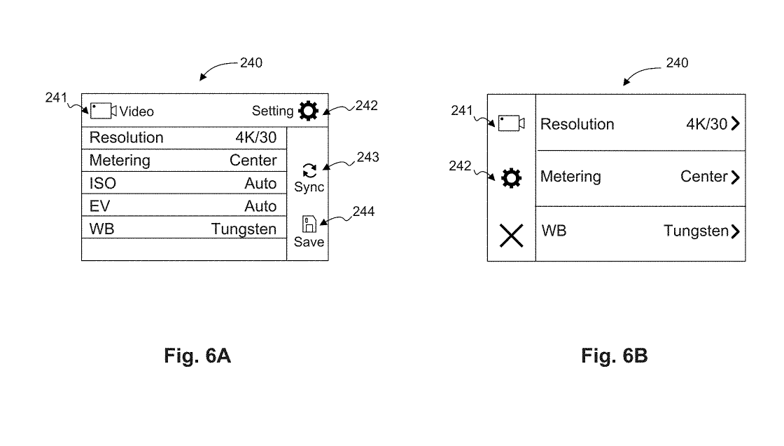

In the disclosed embodiments, controller 220 may instruct user interface 240 to switch among the photo recording mode, the video recording mode, and the time-lapse video recording mode, and allow the operator to select the desired operation parameters for each imaging mode. For example, FIG. 6A is a schematic diagram illustrating an operation-parameter displaying page shown by user interface 240, according to an exemplary embodiment. Referring to FIG. 6A, the operation-parameter displaying page displays a video icon 241, indicating that the displayed operation parameters are for use in the video recording mode. The operation-parameter displaying page shows some of the operation parameters used for the video recording mode. The operation parameters may be previously saved by the operator or preset by the manufacturer of system 200. Alternatively, the operation parameters may be newly entered by the operator, and the operator may press a save button 244, such that controller 220 saves the newly entered operation parameters for quick and easy retrieval in the future.

If the operator wants to enter and/or change the values of the operation parameters, the operator may press a setting button 242 and instructs controller 220 to display via user interface 240 a page for setting the operation parameters. FIG. 6B is a schematic diagram illustrating an operating-parameter setting page shown by user interface 240, according to an exemplary embodiment. Referring to FIG. 6B, in the operating-parameter setting page, the operator may select the value for an operating parameter from a pool of predetermined values. For example, camera modules 210 may be capable of recording image data at a resolution of 2.5K at 30 fps or 4K at 30 fps. The operator may select one of these two resolutions.

After the operator selects a desired imaging mode and operation parameters used in the imaging mode, controller 220 may synchronize the selected imaging mode and operation parameters to some or all the camera modules 210. For example, referring to FIG. 6A, the operator may press a synchronization button 243 displayed on user interface 240, such that controller 220 applies the selected imaging mode and operation parameters to one or more pre-selected camera modules 210.

The term “synchronizing” in this disclosure, when used in conjunction with “imaging mode” and/or “operation parameters,” refers to applying, by controller 220, the user-defined imaging mode and/or operation parameters to user-selected camera modules 210. In the disclosed embodiments, according to the specific use scenario, controller 220 may instruct different groups of camera modules 210 to use different imaging modes and/or different values for the operation parameters. Certainly, in some use cases, controller 220 may also apply the same imaging mode and/or the same operation parameters to all the camera modules 210. For example, referring to FIG. 5A, the operator may select Cameras 01-08 (e.g., by pressing and selecting the buttons representing Cameras 01-08) and operate controller 220 to synchronize a first shutter speed, e.g., 1 s, to Cameras 01-08. The operator may further select Cameras 09-17 and operate controller 220 to synchronize a second shutter speed, e.g., 2 s, to Cameras 09-17. As another example, to record certain special VR effects, controller 220 may instruct side view Cameras 01-08 to use the video recording mode, side view Cameras 09-16 to use the time-lapse video recording mode with a time interval of 1 s, and top view Camera 17 to use the photo recording mode.

Referring back to FIG. 4, in step 440, after instructing camera modules 210 to set the imaging mode and operation parameters inputted by the operator, controller 220 may further verify whether the imaging mode and the operation parameters have been synchronized successfully. If the synchronization is successful, controller 220 may proceed to step 450. Otherwise, controller 220 may generate an alert/error message and/or repeat step 430.

As described above, the creation of high-quality VR content requires the user-defined imaging mode and operation parameters to be properly synchronized among camera modules 210. That is, the imaging mode and operation parameters used by different camera modules 210 should be preciously set as specified by the camera operator. As such, each time when the operator changes the settings for camera modules 210, controller 220 may need to verify whether the new settings have been successfully synchronized among camera modules 210.

For example, to shoot a dynamic scene (e.g., a scene with moving objects or changing light intensity), it is critical to precisely synchronize the image capturing at frame level or even sub-frame level among all the camera modules 210. Therefore, the operator may desire all the camera modules 210 to use the same shutter speed. Accordingly, controller 220 may verify whether the same shutter speed have been successfully synchronized among all the camera modules 210. If the mode/parameter synchronization is unsuccessful, controller 220 may display an alert/error message on user interface 240, indicating the mode/parameter synchronization has failed and prompting the operator to perform step 430 again. As another example, the operator may set the ISO used by side view camera modules 32 to be 1600 and the ISO used by top view camera modules 34 to be 800. After instructing side view camera modules 32 and top view camera modules 34 to set these ISO values, controller 220 may further check whether the ISOs have been set as instructed. If the ISOs are set correctly, controller 220 may proceed to step 450. Otherwise, controller 220 may return to step 430.

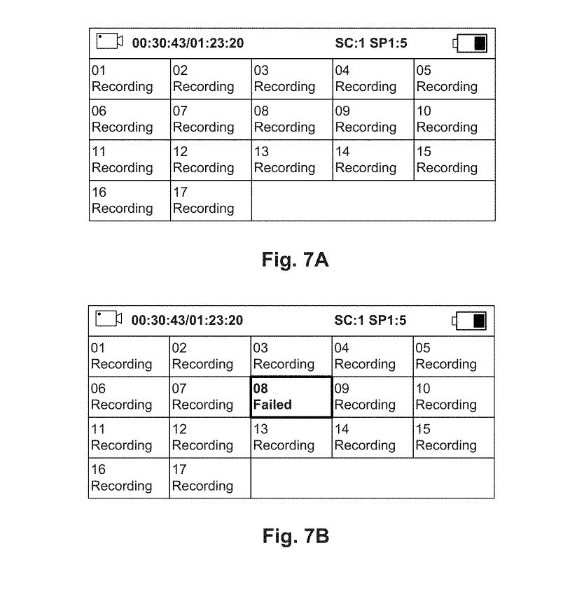

Still referring to FIG. 4, after the hardware/software conditions are checked and the operation parameters are successfully synchronized, camera modules 210 may be determined to be ready for recording image data. Then, in step 450, controller 220 may instruct camera modules 220 to initiate the recording of image data. For example, when camera modules 220 are ready for the recording, hot button 45 may serve as a shutter control for starting (or stopping) image recording. Specifically, when the camera operator presses hot button 45, controller 220 may send a trigger signal to camera modules 210. The trigger signal instructs camera modules 210 to open the shutters and start recording image data at the same point of time. FIG. 7A is a schematic diagram illustrating user interface 240 after image recording is initiated, according to an exemplary embodiment. Referring to FIG. 7A, user interface 240 displays that Cameras 01-17, e.g., sixteen side view camera modules 32 and one top view camera module 34, are recording image data properly.

Referring back to FIG. 4, in step 460, after the image recording is initiated, controller 220 may monitor the operation status of camera modules 210 over time. Specifically, controller 220 may periodically receive signals from each camera module 210, which indicate various aspects of the camera module 210's operation status.

In some embodiments, controller 220 may be configured to monitor a group of pre-selected key performance indicators (KPI) of camera modules 210. The KPIs are parameters capable of measuring the camera operation status. The KPIs may include but are not limited to: the operation parameters (e.g., shutter speed, clock signals, etc.) of camera modules 210; the operation temperature of camera modules 210; the SoC, SoH, and remaining time of the batteries used by camera modules 210; the remaining free storage space in the memory cards; the health of the memory cards (e.g., the temperature of a memory card, the writing speed and/or reading speed of a memory card, etc.); whether any camera module 210 has experienced a system crash; and whether any camera module 210 accidentally stopped the image recording.

For example, controller 220 may continuously monitor whether the imaging modes and/or operator mode originally set in step 430 are maintained during the entire course of the image recording. If it is determined that one or more camera modules 210 unexpectedly change the originally set imaging mode and/or operation parameters, controller 220 may conclude an error has occurred.

As another example, each camera module 210 may include one or more temperature sensors for measuring the camera module 210's operation temperature and reporting the operation temperature to controller 220.

As another example, each camera module 210 may include a battery monitoring system for monitoring the SoC and/or SoH of the battery. The term “state of charge,” as used in the present disclosure, refers to the remaining charge in the battery as compared to the amount of charge when the battery is fully charged. Therefore, the SoC may be expressed as a percentage of the fully charge state. In the disclosed embodiments, the battery monitoring system may monitor the output voltage of the battery, voltages of individual cells in the battery, current in and/or out of the battery, etc., to determine the SoC. The term “state of health,” as used in the present disclosure, refers to one of more of a capacity of the battery, an internal resistance of the battery, self-discharge characteristics of the battery, and/or cell temperature of the battery. Based on the SoC, the SoH, and/or current load of the battery, the battery monitoring system may determine the battery remaining time. Alternatively, the battery monitoring system may send the detected SoC and/or SoH to controller 220 for determining the battery remaining time. For example, controller 220 may use a battery module or run a simulation to compute the remaining time based on the current SoC, the current SoH, the current tasks performed by camera modules 210, and the power specifications of camera modules 210.

In some embodiments, the operator may select and/or define, via user interface 240, the KPIs to be monitored by controller 220. For example, if camera modules 210 are connected to an external power source and do not rely on their own batteries, controller 220 may be relieved from the burden of monitoring the battery remaining time. In contrast, if camera modules 210 are powered by the batteries, the operator may set or add the battery remaining time as a KPI to be monitored by controller 220.

In step 470, when an abnormal operation status is detected, controller 220 may instruct camera modules 210 to stop the image recording and/or generate an alert message indicating the abnormal operation status.

In particular, when one or more of the monitored KPIs exceed predefined normal ranges, controller 220 may conclude an abnormal operation status has occurred. For example, camera modules 210 are designed to operate in certain temperature range. When the operation temperature of a camera module 210 exceeds or drops below a predetermined temperature, controller 220 may conclude that the camera module 210 needs to be turned off immediately in order to avoid damages to the camera module 210.

For another example, when controller 220 detects that the remaining free storage space in a camera module 210's memory card has dropped below a predetermined percentage, e.g., 5%, of the total storage space, controller 220 may conclude that the memory card needs to be replaced with another memory card with more empty storage space.

Similarly, when detecting that the health of a camera module 210's memory card has deteriorated, controller 220 may conclude the camera module 210 has an abnormal operation status. Moreover, when it is detected that a camera module 210 accidentally stopped recording or had a system crash, controller 220 may conclude the operation status of the camera module 210 is abnormal.

For yet another example, when camera modules 210 are performing synchronized imaging, even if both the frame capturing and encoding in different camera modules 210 are initiated simultaneously, the synchronization may still be destroyed because of subsequent clock drifts in part or all of the camera modules 210. Consistent with the disclosed embodiments, the clock drifts may be avoided by using a common clock signal generated by a single crystal oscillator to drive all the camera modules 210. However, if in some embodiments each camera module 210 relies on its own crystal oscillator for providing the clock signal, the clock signal in one camera module 210 may gradually drift apart or desynchronize from the clock signal in another camera module 210, due to the frequency error inherent to each crystal oscillator and the discrepancy in accuracy across different crystal oscillators. Thus, in these embodiments, when detecting the clock draft between any two camera modules 210 exceeds a predetermined level, controller 220 may conclude the imaging synchronization is lost and stops the image recording. Controller 220 may further remind the operator to restart the image recording or automatically restart the image recording, such that the synchronization may be restored.

In some embodiments, when an abnormal operation status is detected, controller 220 may instruct all the camera modules 210 to stop recording image data. For example, many VR applications require all camera modules 220 to record the image data simultaneously. Thus, there is no need to keep other camera modules 210 working when a camera module 210 has failed.

Additionally or alternatively, controller 220 may generate an alert message when an abnormal operation status is detected. In one embodiment, controller 220 may instruct the camera module 210 detected with the abnormal operation status to generate a warning sound, so as to alert the camera operator to the abnormality. Certainly, controller 220 may also be configured to broadcast the warning sound itself or flash a signal light. In another embodiment, controller 220 may instruct user interface 240 to indicate the detected abnormal operation status. FIG. 7B is a schematic diagram illustrating user interface 240 when an abnormal operation status is detected, according to an exemplary embodiment. Referring to FIG. 7B, controller 220 may display, via user interface 240, the real-time operation status of camera modules 210. For example, user interface 240 displays that Camera 08 has failed while other camera modules 210 are still recording the image data properly.

In some embodiments, controller 220 may decide whether to stop the image recording or generate an alert message, based on the the values of the detected KPIs. For example, when the battery remaining time of one or more camera modules 210 is below a first threshold, e.g., 20 minutes remaining or 10% of the fully charged state, controller 220 may alert the camera operator to stop the image recording. However, if this situation gets unattended and keeps worsening, such as when the battery remaining time drops below a second threshold, e.g., 5 minutes remaining or 5% of the fully charged state, controller 220 may automatically stop the image recording, to prevent any unintended shutdown from causing damages to the already-recorded image data, e.g., corrupting the saved image files. As such, the first threshold may be referred to as an “alert threshold,” while the second threshold may be referred to as a “shutdown threshold.”

As described above, controller 220 may monitor multiple KPIs simultaneously and each KPI may have its respective alert threshold and shutdown threshold. By monitoring various KPIs and comparing the KPIs with their respective thresholds, controller 220 may form a comprehensive understanding of the operation statuses of camera modules 210, and quickly and accurately react to the exact situation happening in camera modules 210. For example, controller 220 may only alert the operator to stop the imaging record when the remaining free storage space of a memory card is below an alert percentage of the total storage space, the operation temperature of a camera module 210 exceeds an alert temperature level, or the remaining time of a battery is below an alert time. Moreover, controller 220 may only alert the operator to stop the imaging record when the remaining free storage space of a memory card is below a shutdown percentage, the operation temperature of a camera module 210 exceeds a shutdown temperature level, or the remaining time of a battery is below a shutdown time.

Referring back to FIG. 4, in step 480, when no abnormal operation status is detected, controller 220 may stop or restart the image recording by camera modules 210 based on user input.

For example, the camera operator may use hot button 45 to start or stop the recording of image data. If system 200 works under the photo recording mode, every time when the operator presses hot button 45, controller 220 may instruct camera modules 210 to take a photo. If system 200 works under the video recording mode or the time-lapse video recording mode, when the operator presses hot button 45 while camera modules 210 are recording, controller 220 may instruct camera modules 210 to stop recording; and when the operator presses hot button 45 when camera modules 210 are not recording, controller 220 may instruct camera modules 210 to start recording again.

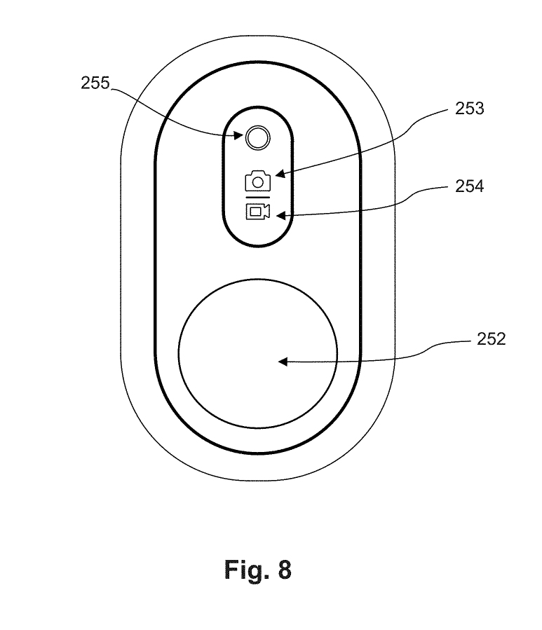

As described above, some or all of the functions of controller 220 may be performed by mobile device 250. In some embodiments, mobile device 250 may be implemented as a remote control which pairs with controller 220 via Bluetooth® connection. FIG. 8 is a schematic diagram illustrating an exemplary Bluetooth® remote control 251. Referring to FIG. 8, remote control 251 may include a start button 252, a first mode selector 253, a second mode selector 254, and a signal light 255. To form a Bluetooth® pairing between controller 220 and remote control 251, the camera operator may press start button 252 to activate remote control 251 so as to make it discoverable by controller 220. Controller 220 may then activate a Bluetooth® radio on control board 230, to search nearby Bluetooth® devices. When recognizing remote control 251, controller 220 may pairs with remote control 251. Signal light 255 may be used to indicate whether the pairing is successful. For example, signal light 255 may flash in red color before the pairing is formed and emit a stable blue light after the paring is successfully formed.

After remote control 251 successfully pairs with controller 220, the operator may use remote control 251 to control certain operations of camera modules 210. For example, when the operator presses first mode selector 253, remote control 251 may transmit a signal to controller 220 and cause controller 220 to instruct camera modules 210 to switch into the photo recording mode. Moreover, when the operator presses second mode selector 254, remote control 251 may similarly cause camera modules 210 to switch into the video recording mode. In one embodiment, when the operator presses both first mode selector 253 and second mode selector 254 simultaneously, remote control 251 may cause camera modules 210 to switch into the time-lapse video recording mode. After the imaging mode is selected, the operator may then press start button 252 to cause camera modules 210 to take photos, or to start or stop video recording.

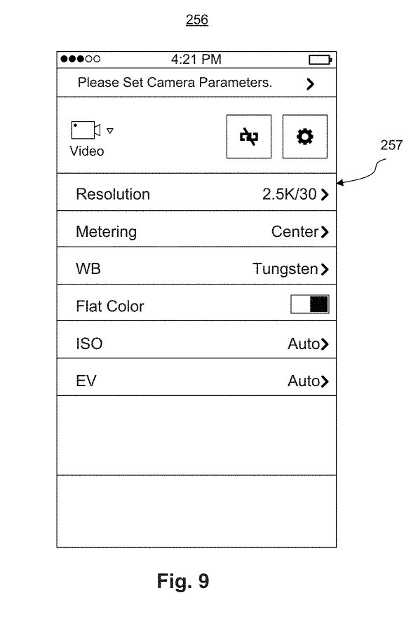

In some embodiments, mobile device 250 may also be implemented as a remote control which pairs with controller 220 via Wi-Fi network. For example, mobile device 250 may be a mobile phone with computing ability (e.g., a smart phone), a tablet computer, a laptop computer, a remote controller, a personal digital assistant (PDA), a wearable device (e.g., a smart watch, a smart wrist band, Google Glass™, etc.). FIG. 9 is a schematic diagram illustrating a user interface 257 of a mobile phone 256, according to an exemplary embodiment. For example, mobile phone 256 may be installed with an application (APP) for controlling system 200. After the App is started, mobile phone 256 may automatically form a Wi-Fi connection with controller 220 via network 260.

Referring to FIG. 9, mobile phone 256 running the App may provide user interface 257 for controlling and monitoring camera modules 210, in a way similar to user interface 240. User interface 257 may allow the camera operator to set the operation parameters of camera modules 210. After receiving the input from the operator, mobile phone 256 may transmit the inputted operation parameters to controller 220, which then synchronizing the inputted operation parameters among all the camera modules 210. Similarly, via controller 220, mobile phone 256 may also perform other operations such as switching the imaging mode of camera modules 210, activating/deactivating one or more camera modules 210, formatting the memory cards used by camera modules 210, starting/stopping image recording by camera modules 210, etc., which are not elaborated here.

Moreover, user interface 257 may also display the hardware/software conditions of camera modules 210 before the image recording starts and the operation statuses of camera modules 210 after the image recording starts, in a way similar to user interface 240 (FIGS. 5A, 5B, 7A, and 7B). Specifically, controller 220 may transmit the detected hardware/software conditions and/or operation statuses to mobile phone 256 for display in user interface 257. This way, the camera operator may remotely check or monitor camera modules 210.

In some embodiments, mobile phone 256 may also provide a preview of the scene before the image recording is started. For example, mobile phone 256 may send a request to controller 220 for previewing the scenes to be shot by one or more selected camera modules 210. Upon receiving the request, controller 220 may instruct the selected camera modules 210 to activate their Wi-Fi functions. Controller 220 may then serve as a Wi-Fi access point and connect the selected camera modules 210 to mobile phone 256. This way, the selected camera modules 210 may stream the image data to mobile phone 256 for image preview.

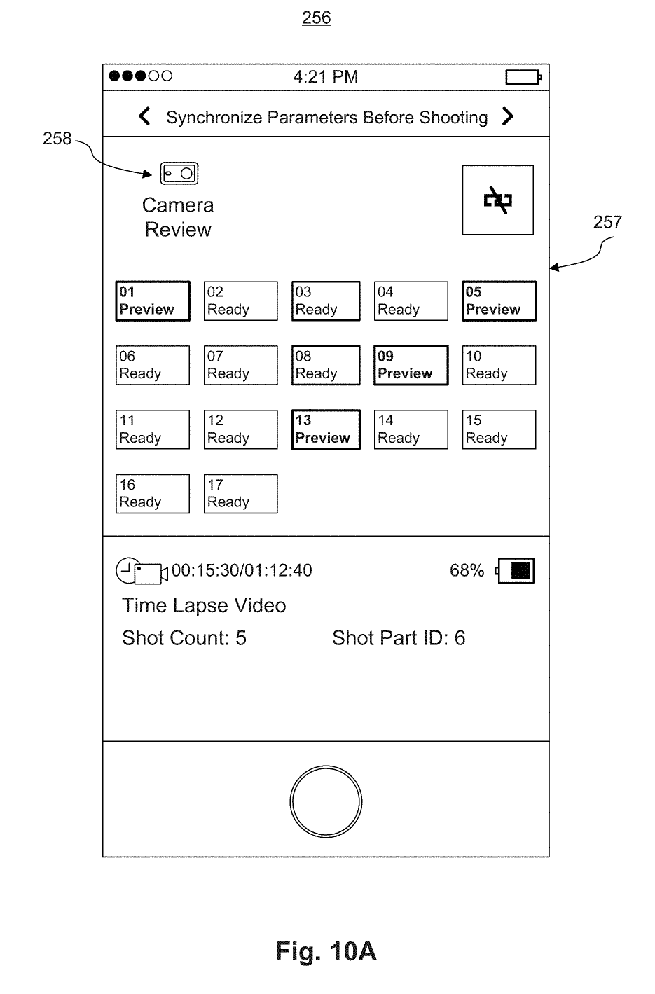

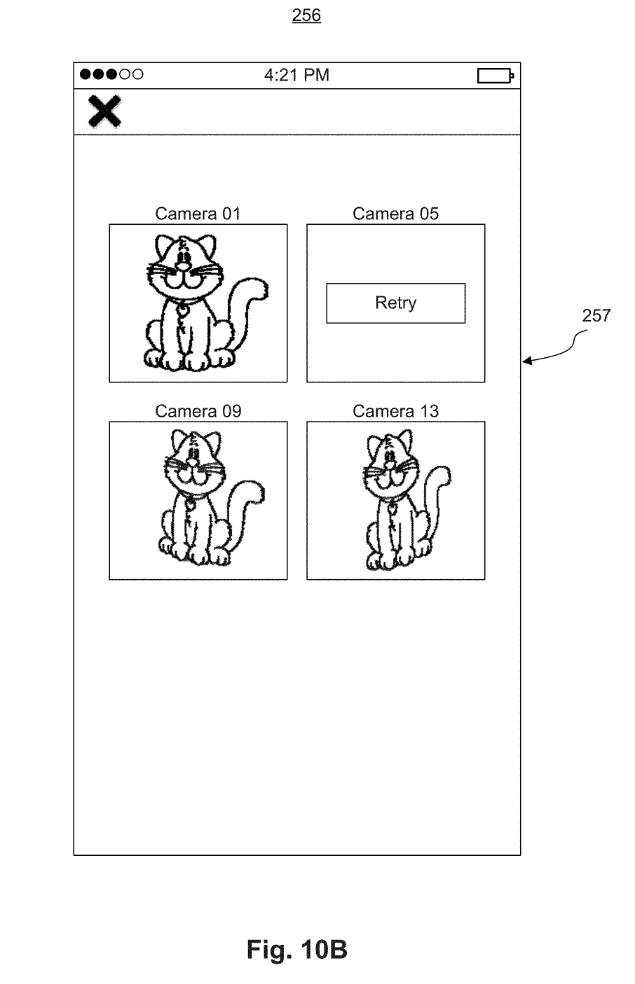

FIG. 10A is a schematic diagram illustrating a user interface 257 for selecting one or more camera modules 210 for image preview, according to an exemplary embodiment. Referring to FIG. 10A, via user interface 257, mobile phone 256 may display a list of camera modules 210 that are ready for recording image data. The camera operator may select, for example, Cameras 01, 05, 09, and 13 for image preview by pressing the icons representing these camera modules. The operator may then press a preview button 258 to enter a preview mode. FIG. 10B is a schematic diagram illustrating a user interface 257 in a preview mode, according to an exemplary embodiment. Referring to FIG. 10B, via user interface 257, mobile phone 256 may display the scenes captured by Cameras 01, 05, 09, and 13. Sometimes, if mobile phone 256 fails to receive the image data from one or more of the selected camera modules 210, e.g., Camera 05, mobile phone 256 may display a failure message and prompt the operator to retry the connection to Camera 05.

Evident from the above detailed description, the disclosed camera-array control system provides a solution to centralize the controlling, checking, and monitoring of a camera array. In particular, the centralized control system makes it possible to synchronize the user settings for a large number of camera modules and the operation (e.g., initiate the recording of image data) by the camera modules, so as to improve the efficiency and accuracy of controlling the camera array. Also, the centralized control system facilitates the communications between the camera operator and the camera array and communications within the camera. These features are beneficial for creating high-quality VR content, which requires multiple camera modules to work in a coordinated manner. Moreover, the disclosed system uses a modular design and does not limit the number of camera modules to be controlled, and thus can be easily expanded. In addition, part or all of the control functions performed by the controller can be performed by various mobile devices, which enable remote control of the camera array and further improve the user experience.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact constructions that are described above and illustrated in the accompanying drawings, and that various modifications and changes can be made without departing from the scope thereof. It is intended that the scope of the invention should only be limited by the appended claims.

What is claimed is:

1. A camera system, comprising:
a plurality of cameras; and
a controller coupled to the cameras and configured to:
activate the cameras;
determine at least one of hardware or software conditions of the cameras;
when the conditions of the cameras are normal, instruct the cameras to initiate an operation;
after the operation is initiated, monitor operation status of the cameras; and
when an abnormal operation status is detected, instruct the cameras to stop the operation.

2. The camera system of claim 1, wherein the controller is further configured to:
before the operation is initiated, instruct the cameras to set:
an operation mode; and
operation parameters used in the operation mode;
determine whether the operation mode and the operation parameters are successfully set by the cameras; and
when it is determined that at least one of the operation mode or the operation parameters is not set successfully, generate an alert message.

3. The camera system of claim 2, wherein the operation mode includes at least one of a photo recording mode, a video recording mode, or a time-lapse video recording mode.

4. The camera system of claim 1, wherein:
the operation is a first operation; and
the controller is further configured to:
before the first operation is initiated, instruct the cameras to perform a second operation.

5. The camera system of claim 1, further comprising:
a user interface configured to display the determined conditions of the cameras.

6. The camera system of claim 5, wherein the user interface is further configured to:
display the operation status of the cameras after the operation is initiated.

7. The camera system of claim 1, wherein the controller is further configured to:
when one or more of the cameras are determined to have an abnormal condition, generate an alert message.

8. The camera system of claim 1, wherein the controller is further configured to:
when the abnormal operation status is detected, generate an alert message.

9. The camera system of claim 1, wherein the controller is further configured to determine the conditions of the cameras by at least one of:
determining temperatures of the cameras;
determining remaining free storage space of memory cards used by the camera;
determining operation parameters preset in the cameras; or
determining versions of software used by the cameras.

10. The camera system of claim 9, wherein the controller is further configured to:
when the cameras are preset with different values for a same operation parameter, conclude that a condition of the cameras is abnormal.

11. The camera system of claim 9, wherein the controller is further configured to:
when values used by the cameras for a same parameter do not follow a predetermined relationship, conclude that a condition of the cameras is abnormal.

12. The camera system of claim 9, wherein the controller is further configured to:
when the cameras use different versions of a same software program, conclude that a condition of the cameras is abnormal.

13. The camera system of claim 1, wherein the controller is further configured to monitor the operation status of the cameras by at least one of:
monitoring temperatures of the cameras;
monitoring operation parameters of the cameras;
monitoring battery remaining time of the cameras;
monitoring remaining free storage space of memory cards used by the cameras;
determining whether one or more of the cameras have stopped the operation; or
determining whether one or more of the cameras have experienced a system crash.

14. The camera system of claim 1, wherein the controller is further configured to:
instruct the cameras to initiate the operation at a same point in time.

15. The camera system of claim 1, wherein the controller is coupled to the cameras via a wired connection.

16. The camera system of claim 1, wherein the controller is further configured to:
establish communication with a mobile device
receive a first signal from the mobile device;
based on the first signal, instruct the cameras to set an operation mode;
receive a second signal from the mobile device; and
based on the second signal, instruct the cameras to initiate the operation.

17. The camera system of claim 1, wherein the controller is further configured to:
establish communication with a mobile device;
receive images captured by one or more of the plurality of cameras; and
transmit the received images to the mobile device, wherein the mobile device is configured to display one or more images.

18. The camera system of claim 1, wherein two or more of the plurality of cameras have overlapping field of views.

19. A method for controlling a plurality of cameras, comprising:
activating the cameras;
determining at least one of hardware or software conditions of the cameras;
when the conditions of the cameras are normal, instructing the cameras to initiate an operation;
after the operation is initiated, monitoring operation status of the cameras; and
when one or more of the cameras have abnormal operation status, instructing the cameras to stop the operation.

20. A non-transitory computer-readable storage medium storing instructions that, when executed by a processor of a controller, cause the processor to perform a method for controlling a plurality of cameras, the method comprising:
activating the cameras;
determining at least one of hardware or software conditions of the cameras;
when the conditions of the cameras are normal, instructing the cameras to initiate an operation;
after the operation is initiated, monitoring operation status of the cameras; and
when one or more of the cameras have abnormal operation statuses, instructing the cameras to stop the operation.
